(19) United States
(12) Patent Application Publication
(10) Pub. No.: US 2026/0229027 A1
(43) Pub. Date: Aug. 6, 2026

(54) OBJECT DETECTION FAILURE MEASURE

(71) Applicant: Telefonaktiebolaget LM Ericsson (publ), Stockholm (SE)

(72) Inventors: Alejandra HERNANDEZ SILVA, Solna (SE); Clara GOMEZ BLAZQUEZ, Madrid (ES); Paula CARBÓ CUBERO, Stockholm (SE); André MATEUS, Stockholm (SE); David UMSONST, Stockholm (SE); Fernando dos Santos BARBOSA, Stockholm (SE); José ARAÚJO, Stockholm (SE)

(21) Appl. No.: 19/150,616

(22) PCT Filed: Jan. 27, 2023
(86) PCT No.: PCT/EP2023/051976

§ 371 Date: Jul. 24, 2025

(51) Int. Cl. G06V 10/94; G06V 10/776; G06V 10/96; H04W 24/08

(52) U.S. Cl. CPC G06V 10/95; G06V 10/776; G06V 10/96; H04W 24/08

(57) ABSTRACT

A computer-implemented method is provided performed by a computing device for determining a measure of an object detection failure based on an awareness of network quality and assistance from a distributed device. The method includes determining a first result of a first object detector of the computing device; and determining a local state of the computing device that includes a first metric of a probability of a failure of the first object detector. The method further includes receiving, from the distributed device, a second result of a second object detector; and determining a global state including a value based on a comparison of the first and second result; obtaining a third metric of a quality of the network; and outputting the measure of the object detection failure based on a merge of the local state, the global state, and the third metric.

### TECHNICAL FIELD

The present disclosure relates generally to a computer-implemented method performed by a computing device for determining a measure of an object detection failure based on an awareness of network quality and assistance from a distributed device in a network, and related methods and apparatuses.

### BACKGROUND

The performance of a distributed Object Detection (OD) process may be monitored. Object detectors are trained on a set of information and they are expected to work similarly when presented with unknown or new data. However, object detectors may struggle to identify objects in some situations (e.g., challenging situations).

Object detection may be further complicated when, e.g., resource-constrained devices (such as devices with small battery power or limited computing capabilities) are involved because object detection is a computationally demanding task. For example, object detection may use deep learning (DL) inference. In addition, fast execution may be needed in order to be useful for other applications such as Simultaneous Localization and Mapping (SLAM) or online semantic mapping, as well as to be acceptable for user experience applications, such as extended reality (XR). These two characteristics, for example, may limit options for resource-constrained devices to lightweight OD models that are normally less accurate and more prone to failures than heavyweight OD models.

### SUMMARY

There currently exist certain challenges. Some approaches to object detection failures, e.g. in resource-constrained devices, may add heavy computation due to the inclusion of a second deep neural network (DNN) to run in the device; use other powerful algorithms or more accurate sensors to use as comparison; and/or be based on heuristic functions and assumptions that oversimplify approaches to object detection failures. As a consequence, object detection capabilities, and accuracy and trust of object detection results of a device may be limited.

Certain aspects of the disclosure and their embodiments may provide solutions to these or other challenges.

In some embodiments, a computer-implemented method performed by a computing device is provided for determining a measure of an object detection failure based on an awareness of network quality and assistance from a distributed device in a network. The method includes determining a first result of a first object detector of the computing device for a detection of at least one object in an image; determining a local state of the computing device. The local state comprises a first metric of a probability of a failure of the first object detector of the computing device to detect the at least one object in the image. The method further includes receiving, from the distributed device, a second result of a second object detector of the distributed device for a detection of the at least one object in the image; and determining a global state. The global state comprises a value based on a comparison of the first result of the first object detector of the computing device with the second result of the second object detector of the distributed device. The method further includes obtaining a third metric of a quality of the network; and outputting the measure of the object detection failure based on a merge of the local state, the global state, and the third metric.

In some embodiments, a computing device is provided that is configured to determine a measure of an object detection failure based on an awareness of network quality and assistance from a distributed device in a network is provided. The computing device includes: processing circuitry; and memory coupled with the processing circuitry. The memory includes instructions that when executed by the processing circuitry causes the computing device to perform operations. The operations include to determine a first result of a first object detector of the computing device for a detection of at least one object in an image; and to determine a local state of the computing device. The local state comprises a first metric of a probability of a failure of the first object detector of the computing device to detect at least one object in the image. The operations further include to receive, from the distributed device, a second result of a second object detector of the distributed device for a detection of the at least one object in the image; and to determine a global state. The global state comprises a value based on a comparison of the first result of the first object detector of the computing device with the second result of the second object detector of the distributed device. The operations further include to obtain a third metric of a quality of the network; and to output the measure of the object detection failure based on a merge of the local state, the global state, and the third metric.

In some embodiments, a computing device is provided that is configured to determine a measure of an object detection failure based on an awareness of network quality and assistance from a distributed device in a network. The computing device is adapted to perform operations. The operations include to determine a first result of a first object detector of the computing device for a detection of at least one object in an image; and to determine a local state of the computing device. The local state comprises a first metric of a probability of a failure of the first object detector of the computing device to detect at least one object in the image. The operations further include to receive, from the distributed device, a second result of a second object detector of the distributed device for a detection of the at least one object in the image; and to determine a global state. The global state comprises a value based on a comparison of the first result of the first object detector of the computing device with the second result of the second object detector of the distributed device. The operations further include to obtain a third metric of a quality of the network; and to output the measure of the object detection failure based on a merge of the local state, the global state, and the third metric.

In some embodiments, a computer program is provided that includes program code to be executed by processing circuitry of a computing device configured to determine a measure of an object detection failure based on an awareness of network quality and assistance from a distributed device in a network. Execution of the program code causes the computing device to performs operations. The operations include to determine a first result of a first object detector of the computing device for a detection of at least one object in an image; and to determine a local state of the computing device. The local state comprises a first metric of a probability of a failure of the first object detector of the computing device to detect at least one object in the image. The operations further include to receive, from the distributed device, a second result of a second object detector of the distributed device for a detection of the at least one object in the image; and to determine a global state. The global state comprises a value based on a comparison of the first result of the first object detector of the computing device with the second result of the second object detector of the distributed device. The operations further include to obtain a third metric of a quality of the network; and to output the measure of the object detection failure based on a merge of the local state, the global state, and the third metric.

In some embodiments, a computer program product is provided that includes a non-transitory storage medium that includes program code to be executed by processing circuitry of a computing device configured to determine a measure of an object detection failure based on an awareness of network quality and assistance from a distributed device in a network. Execution of the program code causes the computing device to perform operations. The operations include to determine a first result of a first object detector of the computing device for a detection of at least one object in an image; and to determine a local state of the computing device. The local state comprises a first metric of a probability of a failure of the first object detector of the computing device to detect at least one object in the image. The operations further include to receive, from the distributed device, a second result of a second object detector of the distributed device for a detection of the at least one object in the image; and to determine a global state. The global state comprises a value based on a comparison of the first result of the first object detector of the computing device with the second result of the second object detector of the distributed device. The operations further include to obtain a third metric of a quality of the network; and to output the measure of the object detection failure based on a merge of the local state, the global state, and the third metric.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram of a system, including a computing device that includes a lightweight OD and a distributed device that includes a heavyweight OD, according to some embodiments;

FIG. 2 is a diagram illustrating the effect of rescaling and sigmoid applied to introspective and global states, according to some embodiments;

FIG. 3A is a diagram illustrating sigmoid relations according to some embodiments;

FIG. 3B is a diagram illustrating linear relations according to some embodiments;

FIGS. 4A, 4B, and 4C are diagrams illustrating network impact on a network aware detection failure metric (N-DFM) according to some embodiments;

FIGS. 5A, 5B, and 5C are diagrams illustrating a repetitiveness impact on N-DFM according to some embodiments;

FIG. 6 is a flow chart illustrating operations of a computing device according to some embodiments;

FIG. 7 illustrates an alternative implementation example of a computing device for particular embodiments of the present disclosure; and

FIG. 8 illustrates three examples of a computing device that may be used to implement particular embodiments of the present disclosure.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents some embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

For ease of discussion, example embodiments herein are explained in the non-limiting context of detection failures in resource-constrained devices (such as small battery power or limited computing capacities). The present disclosure, however, is not so limited and some embodiments include other devices (e.g., computing devices, etc.).

Predicting the probability or degree of detection failure along with a detection inference may be lacking.

While some approaches may assess how well an object detector performs, such approaches may be deficient. Some approaches extract some internal features from centralized DL-based object detectors and combine them with other classifiers to predict a failure or success in an image frame. For example, in “Per-frame mAP prediction for continuous performance monitoring of object detection during deployment” (Rahman, Q. M., Sunderhauf, N., & Dayoub, F., Proceedings of the IEEE/CVF Winter Conference on Applications of Computer Vision (pp. 152-160) (2021)), features extracted from the last layer of an object detection network are fused with a binary classifier to predict when per-frame accuracy degrades. In “Online Monitoring of Object Detection Performance During Deployment” (Rahman, Q. M., Sünderhauf, N., & Dayoub, F., 2021 IEEE/RSJ International Conference on Intelligent Robots and Systems (IROS) (pp. 4839-4845) (2021)), a cascaded network exploits the internal features from the deep neural network of the object detector to extract feature maps that feed a second network that works using sliding windows to predict the quality of the detector. Such approaches in detection failure for object detection processes may achieve good results by using the outputs from the object detection inference or intermediate features in the inference to train a second DNN to predict the accuracy of the original detection. However, while such approaches may be able to identify when the object detector accuracy falls below a certain threshold, the impact of including a more complex and heavier network on the platform metrics is not shown.

In “Introspective perception: Learning to predict failures in vision systems” (Daftry, S., Zeng, S., Bagnell, J. A., & Hebert, M., 2016 IEEE/RSJ International Conference on Intelligent Robots and Systems (IROS) (pp. 1743-1750) (2016)), a deep spatio-temporal convolutional network is trained to learn good invariant hidden latent representations. The resulting features are then used as input to train a linear Support Vector Machine (SVM), which generates a failure prediction score as output. However, the inputs to the classifier are two subsystems based on a convolutional neural network (CNN) (spatial and temporal), and thus a more complex architecture is needed to detect failures.

Applying such approaches to resource-constrained devices, for example, may not be possible in a real setup, as they may have strong latency requirements that cannot be met with a system that requires executing two or more consecutive deep learning processes. In addition, having such complex processes in a resource-constrained device increases its energy consumption, reducing battery life.

An approach to know how well a detector works may be to evaluate its predictions against a ground truth. However, in real-time applications the absence of ground truth complicates a measurement of the accuracy of the model.

Some approaches may try to identify inconsistencies in the object detector by analyzing features from the outputs of the detector without needing ground truth. For instance, features like bounding boxes' confidences and mean overlapping may be used to identify false negatives (temporal and stereo inconsistencies) between a pair of similar images. This information is filtered and then used to try to identify object detector errors. (See e.g., Ramanagopal, M. S., Anderson, C., Vasudevan, R., & Johnson-Roberson, M “Failing to learn: Autonomously identifying perception failures for self-driving cars”, IEEE Robotics and Automation Letters, 3 (4), 3860-3867 (2018). Ramanagopal describes use of a combination of sensors to evaluate the differences between them+-that the approach is not applicable to most resource-constrained devices that have a limited range of sensors (for example, a monocular camera for object detection) and adding a stereo camera or lidar would increase the weight and cost of the device.

Other approaches may use an expensive profiling of possible configurations. For example, in “Chameleon: scalable adaptation of video analytics” (Jiang, J., Ananthanarayanan, G., Bodik, P., Sen, S., & Stoica, I., Proceedings of the 2018 Conference of the ACM Special Interest Group on Data Communication (pp. 253-266) (2018 August)), discusses powerful algorithms that through result comparison evaluate the performance of an object detector. A drawback of such an approach is that the approach assumes that the powerful algorithm is always better than a lighter one, which may not always be the case. Another drawback of such an approach is that the approach may need temporal execution of the powerful algorithm in the device to compare with other less powerful options, which can lead to an increase in energy consumption. To try to overcome this drawback, the execution of the more powerful algorithm may be offloaded to an edge, however this setup can be highly affected by network issues and may be unable to check the accuracy of the object detector in poor network conditions.

Moreover, detection failure or accuracy methods for, e.g., resource-constrained devices (for example, in the context of offloading) may tend to oversimplify the problem by assuming that a more complex object detector will always have a better performance (see e.g., Jiang; and/or “Offloading Optimization in Edge Computing for Deep-Learning-Enabled Target Tracking by Internet of UAVs,” (B. Yang, X. Cao, C. Yuen and L. Qian, IEEE Internet of Things Journal, vol. 8, no. 12, pp. 9878-9893, doi: 10.1109/JIOT.2020.3016694 (15 Jun. 15, 2021); or by defining the accuracy based on other metrics that although they affect accuracy do not have a consistent measurable impact on accuracy (e.g., image resolution). (See e.g., In “DeepDecision: A Mobile Deep Learning Framework for Edge Video Analytics” (X. Ran, H. Chen, X. Zhu, Z. Liu and J. Chen, IEEE INFOCOM 2018-IEEE Conference on Computer Communications, pp. 1421-1429, doi: 10.1109/INFOCOM.2018.8485905 (2018)). Such oversimplification of these accuracy metrics in these approaches can lead to unnecessary use of the network and servers as they tend to assume that offloading to the edge always improves accuracy.

Certain aspects of the disclosure and their embodiments may provide solutions to these or other challenges. The present disclosure relates to a computing device that determines a detection failure in an object detection (OD) process based on an output of the OD process. A distributed device is included that includes an OD (e.g., an edge/cloud-assisted device). Thus, a system includes two object detectors, e.g., a lightweight OD running at the computing device and a heavyweight OD running at the distributed device (e.g., at the edge or cloud). The output is sometimes referred to herein as a network-aware detection failure as the combination between the two metrics takes into account the network quality.

Operations of examples use as inputs sequences of images captured from the environment and outputs object detections and a detection failure metric that indicates the probability that the detector is failing. The operations include, first, inferring the probability of failure of the lightweight OD that runs in the computing device using an introspective (also referred to herein as “local”) module. Then, if the network is available, this estimation is extended with a global module that compares the outputs from the lightweight OD in the computing device and the heavyweight OD in the distributed device. The combination of these two metrics also considers the network quality as its degradation can affect the performance of the global module. This combination in the output is referred to herein as a network-aware detection failure metric (N-DFM). The N-DFM can be exploited to control offloading of the OD process, to expose the performance to a user or to bias a further action to be performed by, e.g., a robot or device.

In some examples, the introspective module calculates the introspective state (also referred to herein as “local state”) that leverages detections from the lightweight OD to estimate its self-behavior based on, e.g., a machine learning (ML) model. The global module considers the comparison between these detections and the detections from the heavyweight OD to calculate the relative performance of the lightweight OD, which is represented by the global state. The introspective state and the global state are computed considering a sliding window and combined to obtain the N-DFM. This combination leverages the performance of the lightweight OD and prevents an assumption that the heavyweight OD is always more accurate.

This detection failure includes a twofold metric between introspective and relative performance. In some examples, it is not assumed that the heavyweight OD always performs better, which leverages the usage of lightweight and fast OD when its performance is accurate.

This detection also includes the integration of network quality in the detection failure metric, as bad network quality can influence the results of the global state leading to an erroneous estimation of the detection failure if network quality is not considered.

Technical advantages provided by certain embodiments of the present disclosure may include that based on inclusion of this output metric, capabilities of an object detection pipeline may be increased by handling the offload process and increasing the exposure of the behavior of the inference, and thus allowing for more informed decisions. Further, as a consequence of the distributed setup, two metrics are combined to estimate detection failure: a learning-based method (the local/introspective state) and the relative measurement (the global state), which may increase accuracy and decrease computational demand at the computing device.

Moreover, real-time detector accuracy may be monitored despite the absence of ground truth, by comparing the inference results of the distributed device without assuming that either of the object detectors always performs better. Additionally, some embodiments include a mechanism to increase the trust of a priori less accurate results through repetitiveness that boosts this advantage.

A further technical advantage provided by certain embodiments of the present disclosure may include that prevention/reduction of misleading detection failures based on the inclusion of the network quality in the calculation of the outputted detection failure metric.

As referred to herein, a “lightweight OD” refers to an algorithm that consumes low power and is faster (e.g., due to a reduced number of layers in a neural network).

As referred to herein, a “heavyweight OD” refers to a process which has higher (e.g., significantly higher) computational requirements and on average is more accurate than a lightweight OD.

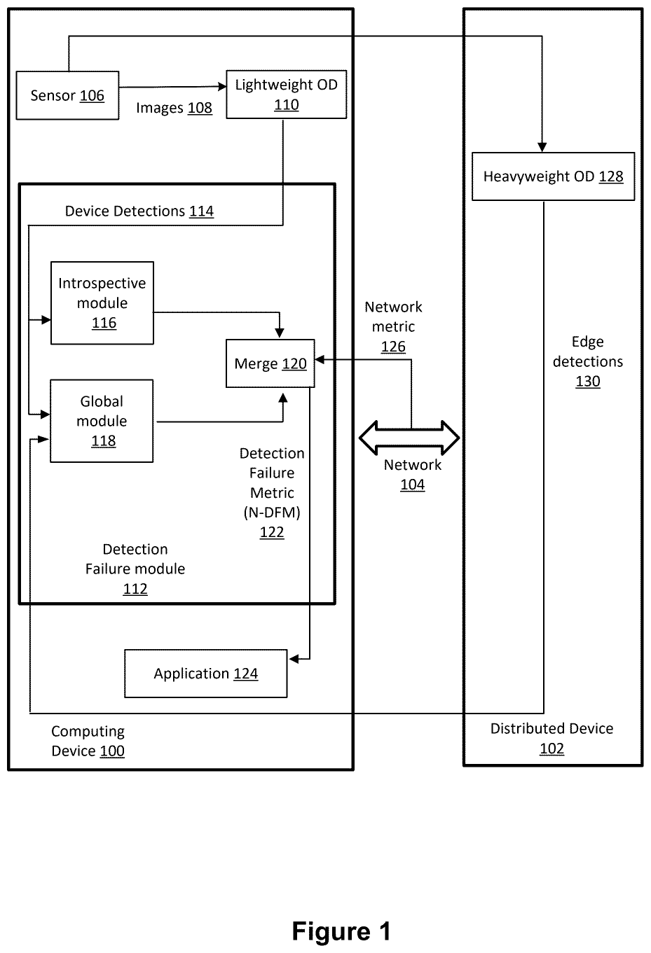

FIG. 1 is a schematic diagram illustrating a system overview in accordance with some embodiments. As shown in the example in FIG. 1, the system includes a computing device 100 that may be a mobile resource-constrained device that executes:
(1) a lightweight OD 110 which takes images 108 as input from a sensor 106 and performs inference of a class of objects and the location of them in the image;
(2) a detection failure module 112 that includes an introspective module 116 and global module 118, wherein the detection failure module 112 executes logic to determine if the results of the lightweight OD 110 are reliable considering two factors: the introspective state and the global state. The introspective state takes into account only the results of the lightweight OD 110 and represents a self-evaluation of the detections of the lightweight OD 110. The global state considers the results from the lightweight OD 110 and edge detections 130 from the heavyweight OD 128 running in the distributed device 102 and represents the relative performance of the lightweight OD compared to the heavyweight OD. Then both metrics are merged 120 and a network metric 126 from the network 104 is also considered to generate the detection failure metric 122;

An application 124 is included in computing device 100 which makes use of the detection failure metric 122. Application 124 may be, e.g., an offloading scheduler or a semantic SLAM method.

Also as depicted in the example of FIG. 1, a distributed device 102 is included. Distributed device 102 may be, e.g., an edge server. Distributed device 102 executes a heavyweight OD 128 which takes images as input and performs inference of the class of objects and the location of them in the image.

In some examples, operations include (1) inferring object detections at the computing device 100 and distributed device 102 from received images; and (2) calculating the detection failure metric 122 for a current sliding window. In some operations, this calculation of the detection failure metric 122 is performed by (1) computing the introspective state from the computing device 100 detections; (2) calculating the global state as a comparison between computing device 100 and distributed device 102 detections; (3) calculating/receiving a network quality metric 126; and (4) merging 120 the introspective state, global state and network quality metric to obtain the outputted detection failure metric 122.

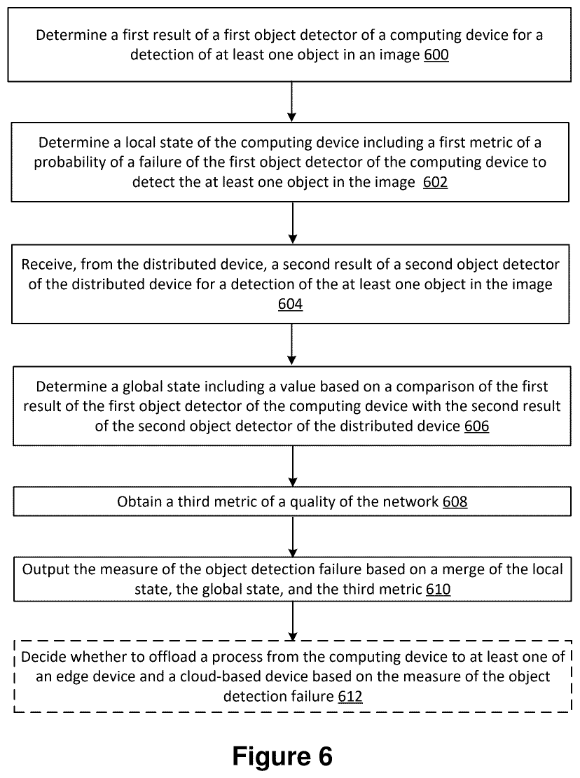

Some embodiments are directed to a method performed by a computing device. As illustrated in FIG. 6, a computer-implemented method is performed by a computing device for determining a measure of an object detection failure based on an awareness of network quality and assistance from a distributed device in a network. The method includes determining (600) a first result of a first object detector of the computing device for a detection of at least one object in an image. The method further includes determining (602) a local state of the computing device. The local state includes a first metric of a probability of a failure of the first object detector of the computing device to detect the at least one object in the image. The method further includes receiving (604), from the distributed device, a second result of a second object detector of the distributed device for a detection of the at least one object in the image. The method further includes determining (606) a global state. The global state includes a value based on a comparison of the first result of the first object detector of the computing device with the second result of the second object detector of the distributed device. The method further includes obtaining (608) a third metric of a quality of the network; and outputting (610) the measure of the object detection failure based on a merge of the local state, the global state, and the third metric.

To infer object detections, images are captured from an environment by the computing device 100 where they are processed. With lower frequency, images are sent to the distributed device 102 where they are also processed to be able to extract performance comparisons (e.g., as edge execution is mostly intended for performance comparison, a lower frequency is acceptable). Both machines (computing device 100/distributed device 102) execute an object detector 110, 128 to infer the object classes and their location in each image frame. For example, in some embodiments, to support the result of the object detector, the outputting further includes outputting an object detection that includes an identification of the at least one object, a location of the at least one object in the image, and a confidence level in the detection of the at least one object.

A lightweight OD 110 that is fast and has low power consumption is executed at the computing device 100 (e.g., tinyYOLOv4). A heavyweight OD 128 runs at the distributed device 102 (e.g., at the edge). A model of the heavyweight OD 128 is heavier and more resource-consuming than the lightweight OD 110 but, on average, offers more accuracy in the prediction (e.g., Full YOLOv4). Object detection executes according to operations that will be understood by those skilled in the art the art including, e.g., calculating the object classes that appear in the image and the bounding boxes that define the location of each object. In some embodiments, a semantic segmentation algorithm (e.g., Mask R-CNN) is applied to obtain the object class at a pixel level and the area occupied by the object in the image.

With the object detections obtained from both machines, the detection failure metric 122 is computed. In some embodiments, the metric 122 is a variable between [0,1] which indicates the probability that the detector 110 in the computing device 100 is failing and, thus, provides a way to know how well a detector is performing. For example, since an object detector can predict the objects that appear in an image based on a pre-trained model, it is susceptible to errors. Generally, these errors can be due to the quality and features of the input data and the configuration of the detection model itself. Therefore, the detector can miss some objects, assign incorrect semantic categories, erroneously locate objects or have a lower confidence score that compromises its reliability.

The detection failure module 112 includes: (1) the computation of an introspective state for a self-evaluation of the detector on the device (e.g., from introspective module 116); (2) the calculation of a global state (e.g., from global module 118) to evaluate its performance against a more robust accurate detector 128; and (3) the merge 120 of these two metrics with network quality metric 126 into a network-aware detection failure metric 122.

Using the two metrics (introspective state and global state) prevents the system from considering the heavyweight OD 128 as the ground truth of the detection by taking into account the self-evaluation or self-trust of the lightweight OD 110.

In some examples, a sliding window is used to avoid false alarms and make the system more robust to noise and sporadic errors in single frames. A time duration M of this sliding window can be fixed or dynamically set. The same or different size of sliding window can be used for the introspective state and the global state. If both sliding windows are of the same duration M, the results from both calculations can be directly merged to generate the detection failure metric 122. If the durations are different (M1 for the introspective state and M2 for the global state) smarter strategies may be needed (e.g. when the results from the sliding window of bigger size, max (M1, M2), are obtained, the median or average of the state for the one with smaller window size can be calculated and then the introspective and the global states can be merged to generate the detection failure metric 122).

For example, in an embodiment, the local state is determined for a first sliding window of images having a first duration and the second metric is determined for a second sliding window of images having a second duration, and the first duration and the second duration is one of a same duration or a different duration.

The introspective state is calculated periodically on the computing device 100 which tells, for example, how well and consistent the detector 110 results are, considering only its self-information. This allows, for example, information on the system performance despite poor network conditions. In this operation, in some embodiments, a machine learning (ML)-based model (e.g., Support Vector Machine or Random Forest) is used to calculate the intrinsic quality of the lightweight OD 110 on the computing device 100. In some embodiments, determining the local state includes calculating the local state from information related to detection of the object.

In some examples, the ML model is trained offline with a set of feature vectors of previous data of past detections. The features can be handcraft features obtained for a sliding window such as the average of the number of detections, the bounding boxes' standard deviation, among others. For example, in some embodiments, the information includes information relating to the at least one object and/or information relating to the image obtained during a training to perform the method.

Simple ML methods (such as the ones mentioned) may be preferred for resource-constrained devices where there is already a shallow deep learning (DL) model running on the computing device 100.

The resulting detections obtained on the computing device 100 at a sliding window of duration M frames are used to extract a set of features that are the input of the introspective module 116. The pre-trained ML model is then applied to infer the introspective state, e.g., a variable between [0,1]. Results close to 1 represent poor detector performance on the computing device 100 and results close to 0 indicate a well-functioning of the detector 110.

For example, in some embodiments, the global state represents a measure of deviation of the first result of the first object detector of the computing device and the second result of the second object detector by the distributed device, and the determining the global state includes a comparison of the first result of the first object detector from a first number of images from the computing device with the second result of the second object detector from a second number of images from the distributed device.

The global state is computed from computing device 100 and distributed device 102 detections. For each sliding window of duration M in time, the F frames coming from the computing device 100 are compared with the F2 (F2<F) frames coming from the distributed device 102. The global state represents, e.g., how much the lightweight computing device 100 results deviate from the heavyweight distributed device 102 results (as in general, a heavyweight OD 128 gives more accurate results and, thus, it can be used as a golden configuration). In some examples, the global state is represented as a variable in [0, 1] built from handcrafted metrics extracted from the detections (e.g. ratio of confidence of the detections, relative mean average precision (mAP), average intersection over union (IoU), etc.). A value of the global state close to 0 means that both detectors 110, 128 obtained similar results and as the value increases it represents higher differences between the results.

As the number of frames coming from the two machines 100, 102 is different, in some examples, a simple frame to frame comparison between frames is not possible (and even if it is possible, it may not be desirable as it may magnify the impact of errors between single frames). Several strategies can be used to compare the frames within the sliding window: (1) An all-against-all strategy that compares the F frames from the computing device 100 against the F2 frames from the distributed device 102. (2) A subdivision of the F frames into two groups to compare each group with its closest F2 frame. Strategies (1) and (2) can reduce the effect of single frame errors by processing several frames together in a sliding window.

For example, in some embodiments, when the first duration and the second duration are the same, the determining (606) the global state includes an image by image comparison of the first result of the first object detector of the computing device with the second result of the second object detector of the distributed device for the first sliding window and the second sliding window.

In another embodiment, when the first duration and the second duration are different, the comparison of the determining (606) includes at least one of (i) an all-against-all comparison of the first result of the first object detector of the computing device with the second result of the second object detector of the distributed device for a plurality of images from the computing device against the plurality of images from the distributed device, and (ii) a subdivision of the plurality of images into at least two groups and a comparison of each of the groups with a closest image.

The global state calculation in some examples depends on network conditions to obtain timely results from the edge. For example, in some embodiments, the third metric of the quality of the network is applied to the global state. If results are not received or they are received outside the sliding window evaluation, the global state would not be calculated for that iteration. In addition, medium-to-low network quality can influence the global state results by including old inferences of the distributed device 102, missing images or receiving corrupted images. Thus, the inclusion of the network quality metric 126 is included in outputting the detection failure metric 122. In some embodiments, the third metric of the quality of the network includes at least one of (i) a measure of network conditions that prevent or delay receiving (604), from the distributed device, the second result of the second object detector of the distributed device for the detection of the at least one object in the image, and (ii) a measure of degradation of network quality based on an out-of-date second metric, at least one missing image, or at least one corrupted image.

Merging introspective and global states combines the results from the computing device 100 only detection failure operation and a computing device 100 and distributed device 102 detection failure operation, namely, the introspective state and the global state. Examples include several operations to merge the variables in order to obtain the network-aware detection failure metric 122 depending, for example, on an application. For example, in some embodiments, the merge of the local state, the global state, and the third metric includes (i) applying a sigmoid function to combine the local state and the global state, and (ii) weighting the global state with the third metric of the quality of the network.

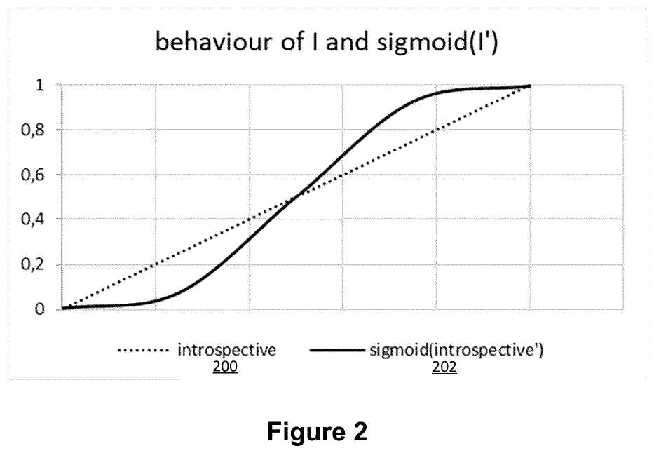

Some examples consider that: (1) high and low values of the introspective and global state can be flattened to prevent a strong influence of the other variable when the first one is quite certain of a good or bad performance, (2) network quality strongly affects the global state, so its influence should be lowered when network quality is compromised and (3) repetitive results for the introspective module strengthen the self-estimation performance trust. Following these considerations, in some examples, the detection failure metric 122 (N-DFM) can be defined as N-DFM=f (I, G, N). An example of N-DFM that follows the considerations can be calculated as:

$$N - DF M = {sigmoid ( {I}^{′} )}^{R} + N * sigmoid ( {G}^{′} )$$

where I′ is a rescaling of the introspective state, R is the number of times that the introspective has been predicting a similar value, N is the network quality and G′ is a rescaling of the global state. As shown in the example of FIG. 2, the introspective state and the global state are rescaled so then the sigmoid function can be applied and values closer to the limits (1 and 0) are more pronounced (as shown by 202) compared to the introspective state (as shown by 200). It is noted that in FIG. 2, the effect of rescaling and applying a sigmoid is just shown for the introspective state as the global state in this example would have the same behavior. In this example, the network quality is a metric that is close to 1 when the network is working properly (e.g., high bandwidth, low latency and low jitter) and decreases (until 0) as the network quality worsens. Given this definition in this example, the N-DFM 122 is an output value in the range [0, 2], but can be thresholded differently for different applications. The general behavior of the N-DFM 122 in this example, and its variables includes the following:
If the introspective state is close to 0 and the global state is close to 0: no failure detected; low detection failure value.
If the introspective state is close to 1 and the global state is close to 1: failure detected; high detection failure value.
If the introspective state is close to 1 and the global state is close to 0: inability to detect failure; the computing device 100 does not trust in its performance, but it is similar to distributed device 102 performance; mid-low detection failure value.
If the introspective state is close to 0 and the global state is close to 1: no agreement in failure; the computing device 100 trusts its performance, but it strongly differs from the distributed device 102 results; mid-low detection failure value that will be highly influenced by the number of repetitions of similar introspection value and the network conditions (as they also state how trustful the global state is).
If R (repetitiveness of the introspective state) is high, the trust on the introspective module increases pushing down the N-DFM 122. On the contrary if R is low, the introspective state is not highly modified.
If N (network quality) 126 is high, it is ok and does not highly modify the global state. On the contrary if N 126 is low, it will affect the trust that the system has in the global module, pushing down the N-DFM 122.

For example, in some embodiments, the measure of the object detection failure includes a value that represents at least one of (i) no failure detected; (ii) a failure detected; (iii) an inability to detect failure; (iv) a lack of agreement in object detection failure between the computing device and the distributed device; (v) when a repetitiveness of the first metric is high, a first trust level of the first metric increases, and when the repetitiveness of the first metric is low, the first metric remains the same; and (vi) an indication of a second trust level of the global state based on the third metric of the quality of the network.

As explained, the network quality 126 and the repetitiveness may especially help in the disambiguation and following decision making when the introspective state and the global state have opposite results; whereas the use of sigmoids may help in having trustful results when both metrics agree.

The approach of the present disclosure can be compared to an approach which uses a linear weighted sum between introspective and global states with fixed weights. Differences between these two approaches include that linear relations are converted into sigmoid ones, the network quality is included in the weighting process (whereas in a fixed-weight approach, it would be considered outside the detection failure process as an additional condition), and the repetitiveness of the introspective state may also added to the operations discussed above.

Regarding the merge of the introspective state and global state as sigmoid functions of examples of the present disclosure, both the introspective and global states are variables in the range [0, 1]. Due to their nature, the introspective state and global state tend to differ from absolute “1” and “O” values, but normally very high or very low values relate to high trustworthiness of the inferred value. In the case of the introspective value, in some examples, this characteristic can come from it being a ML model output and ML methods may not obtain absolute certainties; and in the case of the global state, in some examples, it comes from a comparison of the bounding boxes between two object detectors and a “1” value would mean a perfect overlap between them which is unlikely even with the same object detector and the same input frame. Applying a sigmoid function to combine these metrics may better captures this characteristic than a linear relation as trustworthy high or low values from each of the metrics are boosted. Thus, when both values are in the low interval, they may benefit from the s-shape of the sigmoid to keep the N-DFM 122 low; and on the contrary, when both values are high, they may impact the N-DFM 122 by pushing it to the upper part of the curve.

Moreover, a combination of different types of sigmoids can lead to special characteristics that benefit different applications. For example, in some embodiments, the sigmoid function includes a combination of a first type of sigmoid function applied to the local state and a second type of sigmoid function applied to the global state.

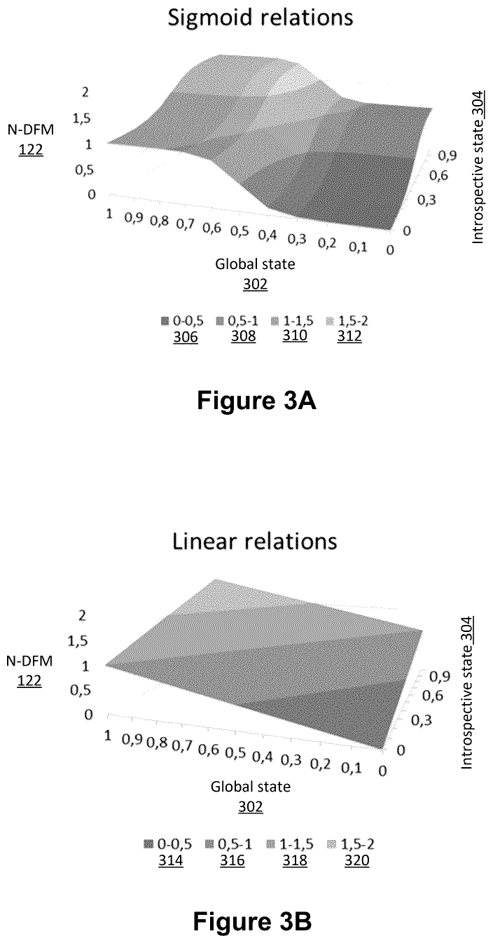

FIG. 3A illustrates the impact on the N-DFM 122 of using a standard sigmoid for the introspective state 304 and a hyperbolic tangent for the global state 302. Values of N-DFM 122 are shown in different shades in FIG. 3A, including values of 0-0.5 (306), 0.5-1 (308), 1-1.5 (310), and 1.5-2.0 (312). FIG. 3B illustrates the impact on N-DFM 122 of using a linear relation of the introspective state 304 and the global state 302, where values of N-DFM 122 are shown in different shades, including values of 0-0.5 (314), 0.5-1 (316), 1-1.5 (318), and 1.5-2.0 (320).

As shown in the example of FIG. 3A, using a standard sigmoid for the introspective state 304 and a hyperbolic tangent for the global state 302 has a positive effect in offloading scenarios when the two metrics strongly disagree. In the case in which the introspective value is low (good performance) and the global is high (the distributed device 122 and computing device 100 results are very different), the approach of the present disclosure can decide to trust the distributed device 102 as it is (e.g., in theory) a more accurate detector and perform offloading. On the contrary, if the introspective value is high (bad performance) and the global value is low (similar results from both detectors 110, 128), the computation will remain in the computing device 100, as both detectors 110, 128 are performing equally bad and offloading may imply a more expensive operation with no guarantee of performance improvement. In an example of this last situation, using the given sigmoids, a difference of at least 30% between the distributed device 102 and the computing device 100 results is needed to perform offloading; whereas with a naïve approach with a linear representation, a difference of 1% will suffice (e.g., leading to unnecessary network and edge usage).

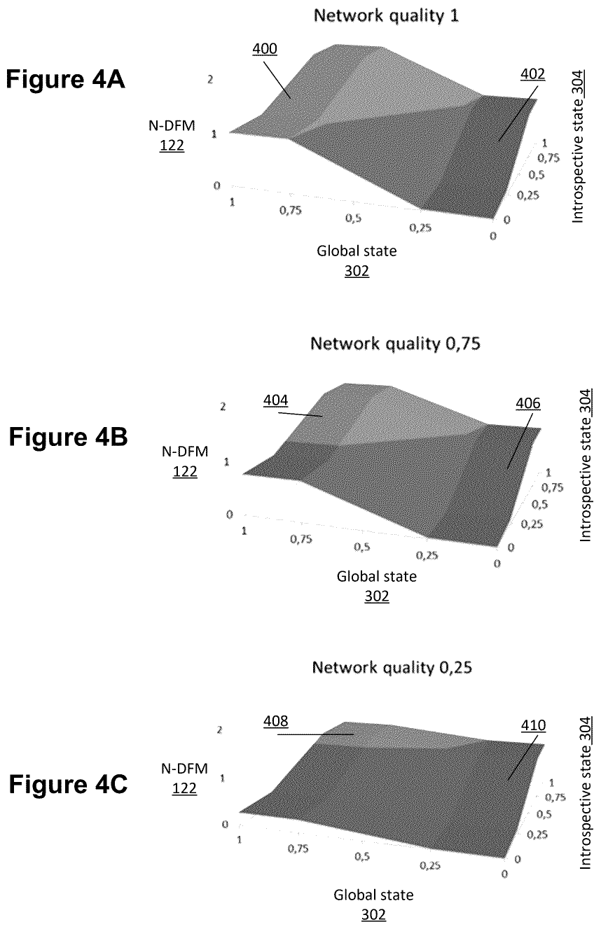

Regarding the inclusion of network conditions in the weighting process, some approaches include an offloading architecture in which network conditions are only considered to determine if the network is in a good enough shape when offloading is needed. However, the examples of the present disclosure focus on detection failure from a network-aware perspective as the results of the detection failure module (e.g., detection failure module 112) depend on the network quality. A reason for this is that the global state includes the comparison of the detection results from the distributed device 102 and the computing device 100, and the results coming from the distributed device 102 are network related. As shown in FIG. 1, for example, the computing device 100 captures the images and they are sent to the distributed device 102 over the network 104. Bad network conditions can affect the transmission by, e.g., images not arriving to the distributed device 102 or arriving corrupted. By adding the network quality 126 as a measurement of the trust that the system can have in the distributed device 102 results, it can identify misleading values of the global state and reduce its impact when facing bad network quality. The effect of network conditions 126 in the N-DFM 122 is shown in the example of FIGS. 4A-4C, which show examples of how, as the network quality 126 decreases, the impact of the global state 302 in the N-DFM 122 is reduced.

In some examples, the system works with sliding windows of frames in order to average detection results, so the impact of outliers is reduced. One example considers that, due to bad network quality, only one image is processed by the distributed device 102. Then, when computing the global state, only the differences between that single result with the multiple results from the computing device 100 are considered. If the results of the computing device 100 are correct, but the single result from the distributed device 102 is wrong, the global state will be very high (meaning that there is a strong difference between the results) which will lead to an increase of the detection failure metric if the network quality 126 is not considered. However, this difference is originated by the network conditions and the lack of sufficient valuable data and the computing device 100 was actually correct in its guess. Thus, adding the weight of the network conditions 126 in this situation can prevent an erroneous value in the detection failure metric 122. Similarly, in another example, bad network conditions can lead to the situation in which the distributed device 102 receives several corrupted images that will again increase the global state having a negative and misleading impact in the N-DFM 122.

Some examples include the addition of the repetitiveness of the introspective state as an exponential bias. In examples of the present disclosure, a technical advantage may include that operations do not trust the more powerful OD 128 in the distributed device 102 by default. The introspective state is a way to balance the trust of both OD 110, 128 and the inclusion of the repetitiveness in the merge function strengthens this property. By adding repetitiveness (that is, a number of consecutive times that the introspective state has predicted a value in the same range), the impact of low and high values is increased. For example, in some embodiments, the merge includes a repetitiveness reflecting a number of consecutive times that the first metric is determined to have a value that is about the same.

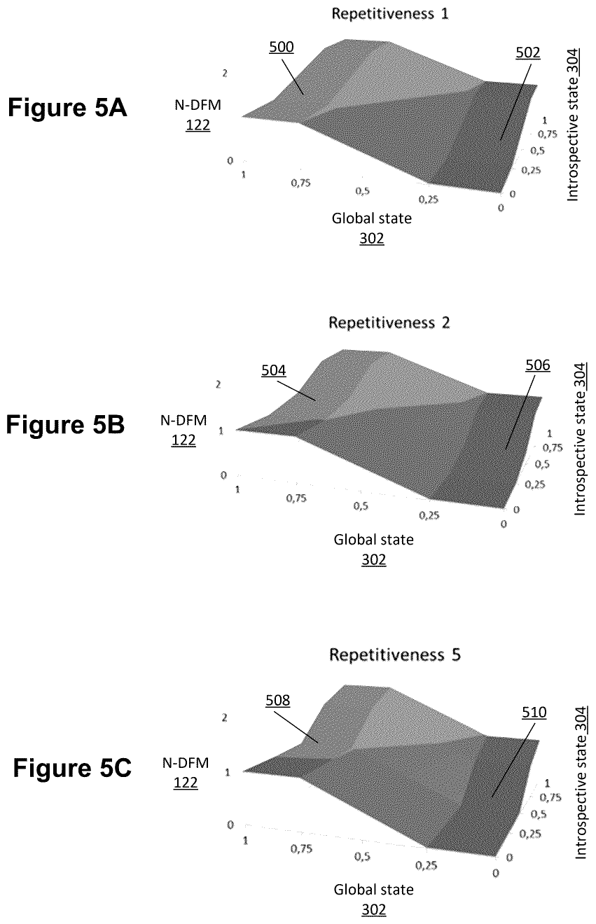

FIG. 5 shows an example of such beneficial behavior for the N-DFM 122. For instance, if the introspective module 116 outputs a low value for the first time and the global state is high, the system will tend to trust the powerful distributed device 102 results. However, as the introspective state keeps maintaining this low value, the trust of the system in this value increases lowering the N-DFM 122.

N-DFM 122 allows getting information related to the status of the system, that is, the trustiness on the information related to semantic objects detected in an environment. This metric can be used as an enabler to control and improve the performance of different applications, as discussed in the following examples that may benefit from N-DFM 122.

A first example includes an offloading decision. In a scenario where a decision is required regarding when to offload different processes to the edge/cloud, the N-DFM 122 can determine when the computing device 100 has a degraded performance and if it could expect better accuracy by offloading to distributed device 102 (e.g., in an edge/cloud). For example, some embodiments further include deciding (612) whether to offload a process from the computing device to at least one of an edge device and a cloud-based device based on the measure of the object detection failure.

As an example of the behavior of the N-DFM 122 for this example, the N-DFM 122 is used to decide whether the OD process needs to be performed by the distributed device 102 or the computing device 100. FIGS. 4A-4C and FIGS. 5A-5C show example situations in which the system will decide to run the process locally in the computing device (as shown by 402, 406, 410, 502, 506, 510) or offload the process to the distributed device 102 (as shown by 400, 404, 408, 500, 504, 508) if the threshold of N-DFM is set at 1 (in a range 0 to 2). In the examples of FIGS. 4A-4C and 5A-5C, the impact of sigmoid relations, network quality, and repetitiveness of the introspective state are shown in the offloading decision.

The usage of sigmoid functions can prevent offloading when the results obtained by the computing device 100 and distributed device 102 are similar (e.g., very similar). For example, a very restrictive offloading threshold may be used to proceed with offloading or onloading when the introspective and global metrics agree in quite high or quite low values. Regarding the network, the offloading is more restrictive as the network quality 126 goes down (e.g., when both metrics agree that the process is running with very low accuracy in the computing device 100). With regard to repetitiveness, as it increases, the trust in the computing device 100 increases. Thus, this can represent an incremental restriction for the offloading task when the N-DFM 122 combines low introspective values and high global values.

In another alternative example, N-DFM 122 is used as an input to a more complex scheduling strategy, where other factors such as power consumption and other platform metrics are usually considered. In this example, N-DFM 122 can be added to a utility function and balance the offload decision by also considering the OD performance.

In another example for a semantic SLAM scenario where semantic 3D maps are created by combining geometric and semantic information, N-DFM 122 can be used to determine how reliable is the semantic information delivered by the object detector. For example, in a place recognition task, if N-DFM 122 is greater than a threshold, this may indicate that the object information is unreliable at that time, which may lead to deciding only to trust the geometric information. On the contrary, if N-DFM 122 indicates that the OD performance is very reliable, the system can include the object information to correct or improve the results. In some embodiments, for example, the measure of the object detection failure is used for a computing task of the computing device to determine a reliability of information related to a detected at least one object in the image.

In some embodiments the distributed device includes at least one of an edge device and a cloud-based device.

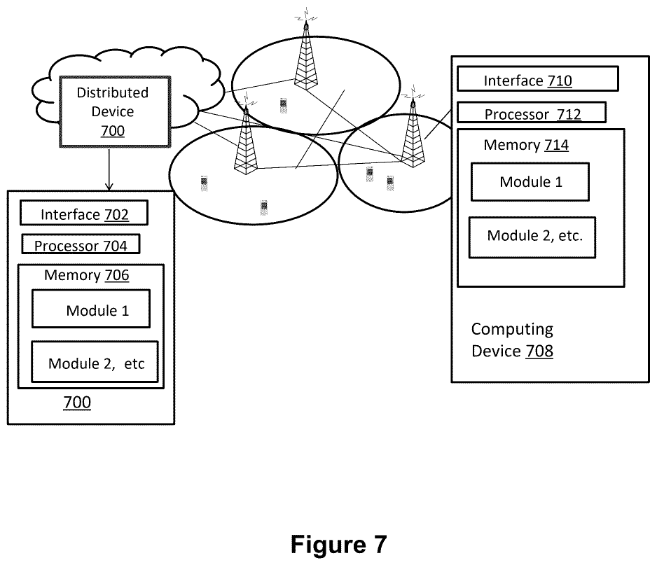

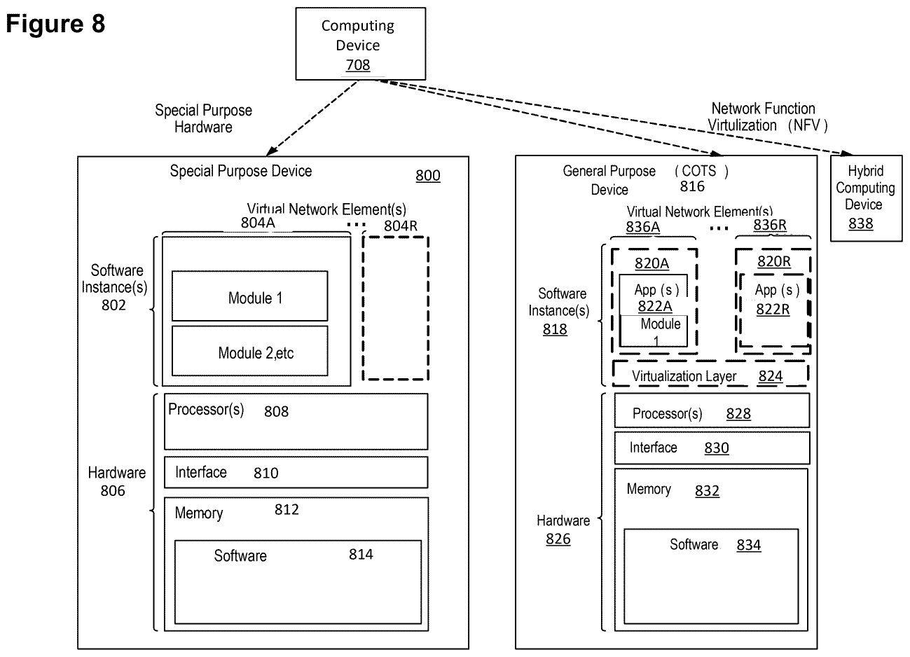

Operations of a computing device can be performed by the computing device 708 of FIG. 7 or 8. Operations of the computing device (implemented using the structure of FIG. 7 or 8) have been discussed with reference to the flow chart of FIG. 6 according to some embodiments of the present disclosure. For example, modules may be stored in memory 714 of FIG. 7 or the memory 814 or 838 of FIG. 8, and these modules may provide instructions so that when the instructions of a module are executed by respective computing device processing circuitry 712, 810, or 834, computing device 708 performs respective operations of the flow chart.

In some embodiments of computing devices and related methods, operations from the flow chart of FIG. 6 may be optional. For example, the operations of block 612 may be optional.

FIG. 7 is a schematic diagram illustrating an implementation of a distributed device 700 in the cloud and computing device 708 in a network. For example, distributed device 700 may be a server, a computer, etc.; and the computing device 100 may be a user equipment (UE), a mobile device, an IoT device, or a constrained device as defined in RFC 7228 or RFC 7548, etc. As depicted in FIG. 7, the example computing device 708 comprises processor 712, memory 714, and interface 710. These components may work together to provide various computing device functionality as disclosed herein. The example distributed device 700 comprises processor 704, memory 706, and interface 702. These components may work together to provide various distributing device functionality as disclosed herein

Processors 704, 712 may be a microprocessor, controller, microcontroller, central processing unit, digital signal processor, application specific integrated circuit, field programmable gate array, any other type of electronic circuitry, or any combination of one or more of the preceding. The processor 704, 712 may comprise one or more processor cores. In particular embodiments, some or all of the functionality described herein as being provided by computing device 708 may be implemented by processor 712 executing software instructions, either alone or in conjunction with other computing device 708 components, such as memory 714. In particular embodiments, some or all of the functionality described herein as being provided by distributed device 700 may be implemented by processor 704 executing software instructions, either alone or in conjunction with other distributed device 700 components, such as memory 706.

Memory 706, 714 may store code (which is composed of software instructions and which is sometimes referred to as computer program code or a computer program) and/or data using non-transitory machine-readable (e.g., computer-readable) media, such as machine-readable storage media (e.g., magnetic disks, optical disks, solid state drives, read only memory (ROM), flash memory devices, phase change memory) and machine-readable transmission media (e.g., electrical, optical, radio, acoustical or other form of propagated signals-such as carrier waves, infrared signals). For instance, memory 706, 714 may comprise non-volatile memory containing code to be executed by processor 704, 712. Where memory 706, 714 is non-volatile, the code and/or data stored therein can persist even when the computing device is turned off (when power is removed). In some instances, while computing device 708 is turned on that part of the code that is to be executed by the processor(s) 712 may be copied from non-volatile memory into volatile memory (e.g., dynamic random access memory (DRAM), static random access memory (SRAM)) of computing device 708. In some instances, while distributed device 700 is turned on that part of the code that is to be executed by the processor(s) 704 may be copied from non-volatile memory into volatile memory (e.g., DRAM, SRAM) of distributed device 700

Interface 702, 710 may be used in the wired and/or wireless communication of signaling and/or data to or from distributed device 700 and computing device 708, respectively. For example, interface 702, 710 may perform any formatting, coding, or translating to allow distributed device 700/computing device 708 to send and receive data whether over a wired and/or a wireless connection. In some embodiments, interface 702, 710 may comprise radio circuitry capable of receiving data from other devices in the network over a wireless connection and/or sending data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas to the appropriate recipient(s). In some embodiments, interface 702, 710 may comprise network interface controller(s) (NICs), also known as a network interface card, network adapter, local area network (LAN) adapter or physical network interface. The NIC(s) may facilitate in connecting the distributed device 700/computing device 708 to other devices allowing them to communicate via wire through plugging in a cable to a physical port connected to a NIC. As explained above, in particular embodiments, processor 704, 712 may represent part of interface 702, 710, and some or all of the functionality described as being provided by an interface may be provided more specifically by processor 704, 712.

The components of distributed device 700 and/or computing device 708 are each depicted as separate boxes located within a single larger box for reasons of simplicity in describing certain aspects and features of distributed device 700 and/or computing device 708 disclosed herein. In practice however, one or more of the components illustrated in the example distributed device 700 and/or computing device 708 may comprise multiple different physical elements (e.g., interface 702, 710 may comprise an over the air interface).

Methods of the present disclosure solution described herein may thus be implemented in the computing device 708 by means of a computer program comprising instructions which, when executed on at least one processor, cause the at least one processor to carry out the actions according to any of the above features and embodiments, where appropriate.

While the modules are illustrated as being implemented in software stored in memory 706, 714, other embodiments implement part or all of each of these modules in hardware.

FIG. 8 illustrates two specific examples of how computing device 708 may be implemented in certain embodiments of the present disclosure including: (1) a special-purpose computing device 800 that uses custom processing circuits such as application-specific integrated-circuits (ASICs) and a proprietary operating system (OS); and (2) a general purpose computing device 816 that uses common off-the-shelf (COTS) processors and a standard OS which has been configured to provide one or more of the features or functions disclosed herein.

Special-purpose computing device 800 includes hardware 806 comprising processor(s) 808, and interface 810, as well as memory 812 having stored therein software 814. In one embodiment, the software 814 implements the modules described with regard to the previous figures. During operation, the software 814 may be executed by the hardware 806 to instantiate a set of one or more software instance(s) 802. Each of the software instance(s) 802, and that part of the hardware 806 that executes that software instance (be it hardware dedicated to that software instance, hardware in which a portion of available physical resources (e.g., a processor core) is used, and/or time slices of hardware temporally shared by that software instance with others of the software instance(s) 802), form a separate virtual network element 804A-R. Thus, in the case where there are multiple virtual network elements 804A-R, each operates as one of the computing devices from the preceding figures.

Returning to FIG. 8, the example general purpose computing device 816 includes hardware 826 comprising a set of one or more processor(s) 828 (which are often COTS processors) and interface 830, as well as memory 832 having stored therein software 834. During operation, the processor(s) 828 execute the software 834 to instantiate one or more sets of one or more applications 822A-R. While certain embodiments do not implement virtualization, alternative embodiments may use different forms of virtualization. For example, in certain alternative embodiments virtualization layer 824 represents the kernel of an operating system (or a shim executing on a base operating system) that allows for the creation of multiple instances 820A-R called software containers that may each be used to execute one (or more) of the sets of applications 822A-R. In this embodiment, software containers 820A-R (also called virtualization engines, virtual private servers, or jails) are user spaces (typically a virtual memory space) that may be separate from each other and separate from the kernel space in which the operating system is run. In certain embodiments, the set of applications running in a given user space, unless explicitly allowed, may be prevented from accessing the memory of the other processes. In other such alternative embodiments virtualization layer 824 may represent a hypervisor (sometimes referred to as a virtual machine monitor (VMM)) or a hypervisor executing on top of a host operating system; and each of the sets of applications 822A-R may run on top of a guest operating system within an instance 820A-R called a virtual machine (which in some cases may be considered a tightly isolated form of software container that is run by the hypervisor). In certain embodiments, one, some or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 826, directly on a hypervisor (in which case the unikernel is sometimes described as running within a LibOS virtual machine), or in a software container, embodiments can be implemented fully with unikernels running directly on a hypervisor represented by virtualization layer 824, unikernels running within software containers represented by instances 820A-R, or as a combination of unikernels and the above-described techniques (e.g., unikernels and virtual machines both run directly on a hypervisor, unikernels and sets of applications that are run in different software containers).

The instantiation of the one or more sets of one or more applications 822A-R, as well as virtualization if implemented are collectively referred to as software instance(s) 818. Each set of applications 822A-R, corresponding virtualization construct (e.g., instance 820A-R) if implemented, and that part of the hardware 826 that executes them (be it hardware dedicated to that execution and/or time slices of hardware temporally shared by software containers 820A-R), forms a separate virtual network element(s) 836A-R.

The virtual network element(s) 836A-R perform similar functionality to the virtual network element(s) 804A-R. This virtualization of the hardware 826 is sometimes referred to as network function virtualization (NFV)). Thus, NFV may be used to consolidate many network equipment types onto industry standard high volume server hardware, physical switches, and physical storage, which could be located in for example data centers and customer premise equipment (CPE). However, different embodiments of the invention may implement one or more of the software container(s) 820A-R differently. While embodiments of the invention are illustrated with each instance 820A-R corresponding to one VNE 836A-R, alternative embodiments may implement this correspondence at a finer level granularity; it should be understood that the techniques described herein with reference to a correspondence of instances 820A-R to VNEs also apply to embodiments where such a finer level of granularity and/or unikernels are used.

The third exemplary ND implementation in FIG. 8 is a hybrid computing device 838, which includes both custom ASICs/proprietary OS and COTS processors/standard OS in a single ND or a single card within an ND. In certain embodiments of such a hybrid computing device, a platform virtual machine (VM), such as a VM that that implements the functionality of the special-purpose computing device 800, could provide for para-virtualization to the hardware present in the hybrid computing device 816.

Although the computing devices described herein (e.g., UEs, mobile devices, etc.) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A computer-implemented method performed by a computing device for determining a measure of an object detection failure based on an awareness of network quality and assistance from a distributed device in a network, the method comprising:
determining a first result of a first object detector of the computing device for a detection of at least one object in an image;
determining a local state of the computing device, the local state comprising a first metric of a probability of a failure of the first object detector of the computing device to detect the at least one object in the image;
receiving, from the distributed device, a second result of a second object detector of the distributed device for a detection of the at least one object in the image;
determining a global state, the global state comprising a value based on a comparison of the first result of the first object detector of the computing device with the second result of the second object detector of the distributed device;
obtaining a third metric of a quality of the network; and
outputting the measure of the object detection failure based on a merge of the local state, the global state, and the third metric.

2. The method of claim 1, further comprising:
deciding whether to offload a process from the computing device to at least one of an edge device and a cloud-based device based on the measure of the object detection failure.

3. The method of claim 1, wherein the outputting further comprises outputting an object detection comprising an identification of the at least one object, a location of the at least one object in the image, and a confidence level in the detection of the at least one object.

4. The method of claim 1, wherein the local state is determined for a first sliding window of images having a first duration and the second metric is determined for a second sliding window of images having a second duration, and wherein the first duration and the second duration is one of a same duration or a different duration.

5. The method of claim 1, wherein the global state represents a measure of deviation of the first result of the first object detector of the computing device and the second result of the second object detector by the distributed device, and the determining the global state comprises a comparison of the first result of the first object detector from a first number of images from the computing device with the second result of the second object detector from a second number of images from the distributed device.

6. The method of claim 4, wherein when the first duration and the second duration are the same, the determining the global state comprises:
an image by image comparison of the first result of the first object detector of the computing device with the second result of the second object detector of the distributed device for the first sliding window and the second sliding window.

7. The method of claim 4, wherein when the first duration and the second duration are different, the comparison of the determining comprises at least one of (i) an all-against-all comparison of the first result of the first object detector of the computing device with the second result of the second object detector of the distributed device for a plurality of images from the computing device against the plurality of images from the distributed device, and (ii) a subdivision of the plurality of images into at least two groups and a comparison of each of the groups with a closest image.

8. The method of claim 1, wherein the determining the local state comprises calculating the local state from information related to detection of the object.

9. The method of claim 8, wherein the information comprises information relating to the at least one object and/or information relating to the image obtained during a training to perform the method.

10. The method of claim 1, wherein the third metric of the quality of the network is applied to the global state.

11. The method of claim 1, wherein the merge of the local state, the global state, and the third metric comprises applying a sigmoid function to combine the local state and the global state, and weighting the global state with the third metric of the quality of the network.

12. The method of claim 11, wherein the sigmoid function comprises a combination of a first type of sigmoid function applied to the local state and a second type of sigmoid function applied to the global state.

13. The method of claim 11, wherein the merge further comprises a repetitiveness reflecting a number of consecutive times that the first metric is determined to have a value that is about the same.

14. The method of claim 1, wherein the measure of the object detection failure comprises a value that represents at least one of (i) no failure detected; (ii) a failure detected; (iii) an inability to detect failure; (iv) a lack of agreement in object detection failure between the computing device and the distributed device; (v) when a repetitiveness of the first metric is high, a first trust level of the first metric increases, and when the repetitiveness of the first metric is low, the first metric remains the same; and (vi) an indication of a second trust level of the global state based on the third metric of the quality of the network.

15. The method of claim 1, wherein the third metric of the quality of the network comprises at least one of (i) a measure of network conditions that prevent or delay receiving, from the distributed device, the second result of the second object detector of the distributed device for the detection of the at least one object in the image, and (ii) a measure of degradation of network quality based on an out-of-date second metric, at least one missing image, or at least one corrupted image.

16. The method of claim 1, wherein the measure of the object detection failure is used for a computing task of the computing device to determine a reliability of information related to a detected at least one object in the image.

17. The method of claim 1, wherein the distributed device comprises at least one of an edge device and a cloud-based device.

18. A computing device configured to determine a measure of an object detection failure based on an awareness of network quality and assistance from a distributed device in a network, the computing device comprising:
processing circuitry;
memory coupled with the processing circuitry, wherein the memory includes instructions that when executed by the processing circuitry causes the computing device to perform operations comprising:
determine a first result of a first object detector of the computing device for a detection of at least one object in an image;
determine a local state of the computing device, the local state comprising a first metric of a probability of a failure of the first object detector of the computing device to detect at least one object in the image;
receive, from the distributed device, a second result of a second object detector of the distributed device for a detection of the at least one object in the image;
determine a global state, the global state comprising a value based on a comparison of the first result of the first object detector of the computing device with the second result of the second object detector of the distributed device;
obtain a third metric of a quality of the network; and
output the measure of the object detection failure based on a merge of the local state, the global state, and the third metric.

19-25. (canceled)
